(19) United States
(12) Patent Application Publication
(10) Pub. No.: US 2012/0211247 A1
(43) Pub. Date: Aug. 23, 2012

(54) Chisel plow leveler rake

(76) Inventor: Jacob Lorenz, Gales Creek, OR (US)

(21) Appl. No.: 13/385,384

(22) Filed: Feb. 15, 2012

Related U.S. Application Data
(60) Provisional application No. 61/463,360, filed on Feb. 17, 2011.

(51) Int. Cl. A01B 49/02

(52) U.S. Cl. 172/191

(57) ABSTRACT

A chisel plow leveler rake assembly connectable to a tractor three point, having a ripper bar with end plates with a vertical tube welded in between, a plurality of plow shoes connected transversely to said ripper bar, said endplates each having a float pivot providing rotational connection for two float bars at a first end, each float bar rigidly connected to a tine bar on the second end, said tine bar having a bottom rear mount welded between said float bars such that an adjustable rear link connects said tine bar whereby the depth of said tine bar relative to said ripper bar is changeable by adjusting the rear link, and a compression bar removably engagable to said tine bar such that a plurality of spike tines, like recycled railroad spikes transversely secure between said tine bar and said compression bar.

### CROSS REFERENCES TO RELATED APPLICATIONS

Provisional Application No. 61/463360

### STATEMENT REGARDING FEDERALLY SPONSORED RESEARCH OR DEVELOPMENT

This invention is not the product of any Federally Sponsored Research or Development.

### REFERENCE TO MICROFICHE APPENDIX

Not Applicable

### BACKGROUND OF THE INVENTION

1. Technical Field

The present invention relates to a three point implement that connects to the back of a tractor for cultivating soil.

2. Discussion of Related Art

One problem of ground cultivation and soil tending with a tractor is that the ground working process generally requires several passes over the same soil area in order to adequately work up, break down, fluff, level, rake, and prepare for either planting of crops or animal habitation. Working and cultivating the soil followed by raking or harrowing is common practice among farmers, gardeners, and those who keep horses and other large animals.

To solve the above problem, several implements are added and towed behind one another like a train, where the tractor is the engine, and the last implement is the caboose for the train analogy. The train lines of implements are each commonly connected by chain or pin, and often don't have wheels, as they simply drag behind working the soil as they go. The train of implements cannot be backed up, and it can't make tight turns. For example, a tractor towing a chisel plow that is connected to a harrow having a drag roller behind it is an arrangement that would facilitate several soil cultivation or soil tending steps in a single pass. However, the short comings are apparent, the user cannot back up the tractor train, so the application of this technique is limited to wide open spaces.

In confined areas like horse arenas, cow paths, or smaller gardens, the long train of farm implements simply is not a viable solution. To further aggravate the problem, each time a tractor drives over the soil being cultivated, there are ruts where the tires compress the soil. With each pass more of the soil is compressed requiring additional work to fluff and level. Therefore it is desirable for the tractor to make a single pass, rather than a plurality of passes, as each pass has a counterproductive secondary compressive affect on the soil. For tight spaces it is a mush to be able to back up the tractor without having to disconnect the implements, which requires the lifting of the implement in order to back up, which commonly is performed by a three point hydraulic assist system that is standard on most tractors.

It is also desirable to take out humps and ridges when cultivating or working soil in order to make for a smooth finished surface. Implements dragged behind on a chain pivot and twist as per the ground that they are being dragged upon, independent of the tractor. The chain method of pulling prevents the tractor motion from impacting the implement pulling dirt, and prevents ups and downs at the tractor wheel from translating to digs and divots at the implement.

Implements that connect by three point do not pivot or twist, and maintain the same horizontal and vertical attitudes of the tractor. This is desirable when the ground is level, as a level tractor maintains a level implement behind. But when there are ridges or humps that the tractor hits at the wheel, the implement being pulled behind goes up and down more dramatically due to the length of the frame between the wheel and the implement. In this way, a three point drag implement can be counterproductive to a smooth finish if the implement follows the tractor motion, rather than improving the cultivated surface.

There is an unsatisfied need for a tractor implement that has the benefits of the three point connection to the back of a tractor allowing it to back up for tight spaces, cultivate, rake, and level all in one pass.

### OBJECTS AND ADVANTAGES

An implement that benefits from:
A leveling bar that is infinitely adjustable in depth and downward pressure.
A three point connection that can be lifted to back into tight or confined areas.
A leveling bar that remains horizontally level to the tractor while free floating from the up and down changes of the tractor.
A rake or harrow feature that uses recycled railroad spikes as tines.
A plow, level, and rake cultivation process in a single tractor pass.
A rake able to self clear debris without the user getting off the tractor.

### SUMMARY OF INVENTION

The invention disclosed herein is constructed and arranged to removably engage onto the back of a tractor's three point system, wherein it may be lifted and lowered in the up and down axis allowing for backing up and turning the tight space. The implement in the preferred embodiment is dragged directly behind the tractor via three point connection to perform cultivation of the ground by the plow shoes first that tills, plows, and rips the soil. Second, the leveling bar floats in the vertical axis and pivots about an axis defined by the horizontal plain of the tractor, thereby it levels, smoothes and fills behind the plow shoes. The final cultivation process is performed by the rake tines extending down and back from the leveling bar providing raking and harrowing of the finished surface. Angle of the shoes can be adjusted at the tractor three point in the same manner commonly practiced in the art. The leveling bar and rake tines are adjusted in a similar way, at a more rearward location. The set pressure on the floating leveling bar and rake is applied by a link between the third link mount and the leveling bar, said link could be a spring, strut, or solid adjustable threaded link. Set pressure on the floating leveling bar can also be increased by the application of added weight.

### BRIEF DESCRIPTION OF DRAWINGS

FIG. 1 is a perspective view of the rear of the chisel plow connected to the leveler rake.

FIG. 2 is a perspective view of the front of the chisel plow connected to the leveler rake.

FIG. 3 is a perspective view of the leveler rake.

FIG. 4 is a depiction of a railroad spike used as a spike tine by the invention.

FIG. 5 is one embodiment of the spacer configuration between the tine bar and compression bar.

### DETAILED DESCRIPTION OF DRAWINGS

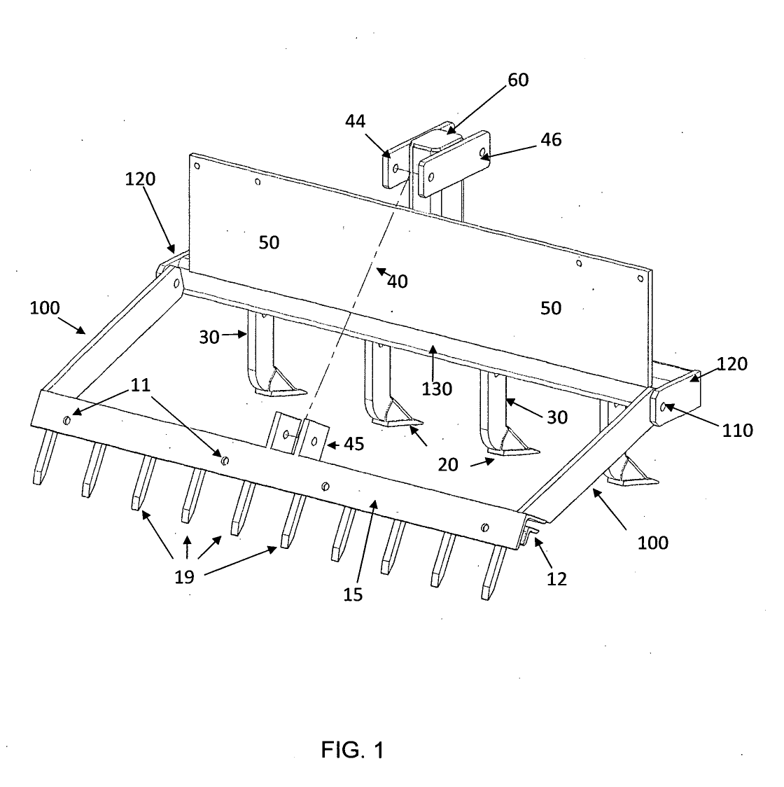

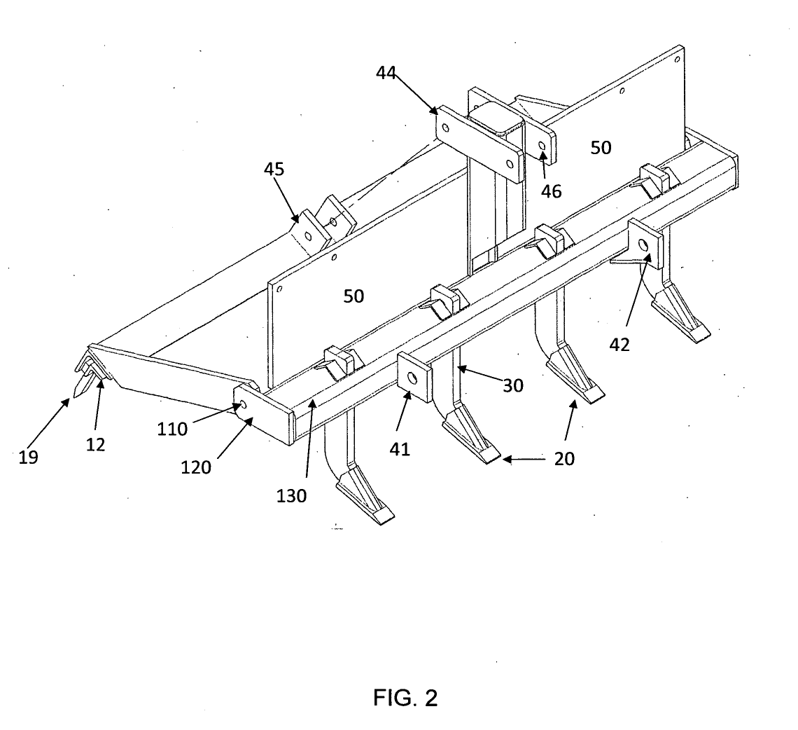

As shown in FIG. 1-2, applicant Lorenz's preferred embodiments is constructed and arranged to be pulled behind a tractor to cultivate, level, rake, plow, rip, and generally tend to soils, clays, sawdust, bedding and different ground mediums. Three point tractor connection methods are well known in the art and are standard across the field of technology, and therefore to increase clarity and provide enablement in this specification, three point tractor hitch technology is not described herein except as the preferred connection method to the tractor.

The chisel plow leveler rake comprises a ripper bar 130 that provides the structure for connection to the three point hitch system at the back of a tractor. A vertical tube 60 fixated at its lower end to the ripper bar 130 and weight bar 50 further having top rear mount 44 and a top front mount 46 fixated at its upper end. The top front mount 46 provides the top link to the three point connection to the tractor.

The ripper bar 130 has end plates 120 at each end and a right link mount 41 and left link mount 42 fixated on the tractor side providing the lower two mounting locations for the three point connection to the tractor. One skilled in the art will know and understand that there are many other ways other than the method shown to connect the disclosed implement to a three point hitch system of a tractor.

The facilitate plowing, ripping, or cultivating, the rippers 30 having shoes 20 on their lower end project down towards the ground and are movably engagable within the ripper bar 130 allowing the user to set the depth of the shoes 20 in relation to the height of the ripper bar 130. In the preferred embodiment, the rippers 30 are aligned side by side, this however is just one possible arrangement of the rippers 30.

The weight bar 50 is fixated atop the ripper bar 130 thereby providing a location for removable mounted ballast weight for applications that so require additional down force at the shoes 20 or when it is desirable to speed up the lowering of the implement.

To facilitate raking, cultivation and leveling the float bars 100 pivotally connect at the float pivot 110 locations at the bar end plates 120 fixated on each end of the ripper bar 130. The float bars 100 rigidly connects on the trailing end to the tine bar 15 that acts as the leveling bar without the spike tines 19, and a rake with leveling bar with the spike tines 19 installed. The float bars 100 may be welded or bolted to the tine bar 15. The preferred embodiment uses two float bars 100, one on each side of the ripper bar 130, however, other embodiments using only one float bar 100 would work as well being connected at the center of the tine bar 15 which would allow for pivoting of the tine bar 15 in the horizontal axis and the vertical axis, or just one or the other. If a grading effect is desired, connecting only one float bar 100 or changing the length of a float bar 100 would angle the tine bar 15 in order to facilitate directional moving of surface soils.

The tine bar 15 has a bottom rear mount 45 approximately centered along its length, and a plurality of tines 19, and at least two tine mount holes 11 spaced between tines 19. The tines 19 can be fabricated, or as the preferred embodiment shows, recycled railroad spikes may be used and held in place by the compression bar 12 having through bolt fasteners passing through the tine mount holes thereby fixating the compression bar with adequate force to hold fast the recycled railroad spike tines 19.

In practice, the height of the ripper bar 130 and the depth of the shoes 20 are set and controlled independently from the float bar 100 with the tine bar 15 and tines 19 free to move independently in the vertical axis from the ripper bar 130, while maintaining the same horizontal orientation of the ripper bar 130, which is aligned with the tractor. In this way, the soil is ripped and fluffed ahead of the tine bar 15 which drags a small amount of soil to level and fill just before the tines 19 rake out debris and further work the soil into a groomed finish. To discard debris, the three point hitch is lifted, and the debris falls from the tines 19 without the user getting off the tractor.

For applications requiring more downward force at the tine bar 15 or tines 19, a compression spring may be added at the rear link location 40 connecting between bottom rear mount 45 and the top rear mount 44 or for applications where less force is desired, a tension spring may be added at the rear link location 40 connecting between bottom rear mount 45 and the top rear mount 44 to help hold up the tine bar 15 and tines 19. In applications that require that the tine bar 15 remain at the same vertical attitude as in relation to the ripper bar 130, a threaded link may be installed at the rear link location 40 to lock the tine bar 15 motion with the ripper bar 130.

When infinite adjustability is required, or for applications where the tine bar 15 needs to be lifted regularly to clear debris captured in the tines 19, a hydraulic cylinder can be installed at the rear link location 40 allowing the user to lift and clear the rake without having to get off of the tractor.

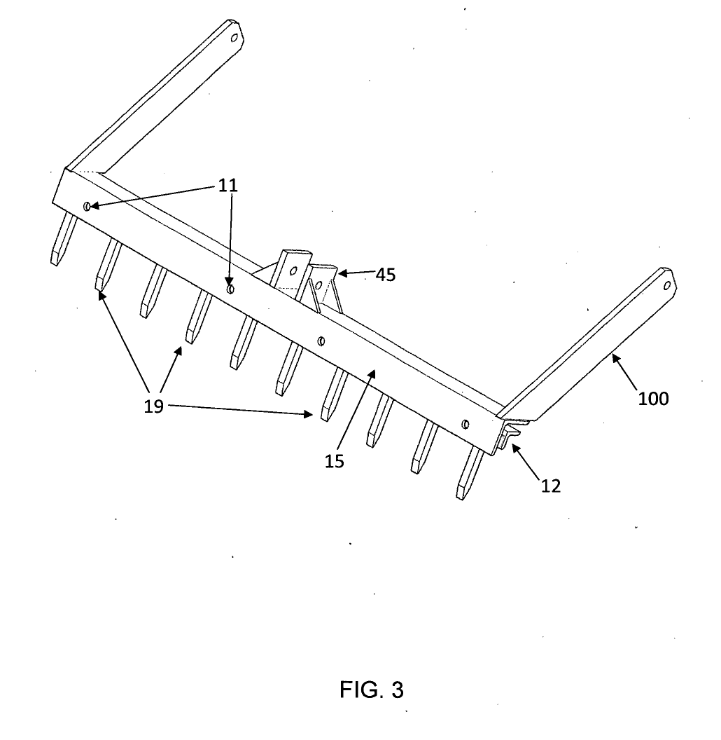

As individually shown in FIG. 3, the tine bar 15 is shown in the preferred embodiment as fixated at approximately 45 degrees from the ripper bar 130 shown in FIGS. 1 and 2. However, one skilled in the art quickly realizes the angle changes that could enhance tine 19 interactions with soils, or be angled forward to improve raking of sticks, hay, or debris from cultivated soils by simply mounting the tines 19 on the forward side of the tine bar 15. The preferred embodiment shows the tines 19 in a more harrowing angle for working the soil surface into a smooth groomed finish.

The floating affect of the tine bar 15 and tines 19 as attached relies upon the float bar 100 being pivotally connected to the implement attached to the three point hitch of the tractor. Many tractor implements such as box scrapers and drags would benefit with the float bar 100 and tine bar 15 pivotally connected on the trailing side, thereby performing an added leveling step. For applications where raking is desired, the tines 19 fixated to the tine bar 15 enables the user to rake up debris, and use the three point hitch to lift and discard without having to get off the tractor.

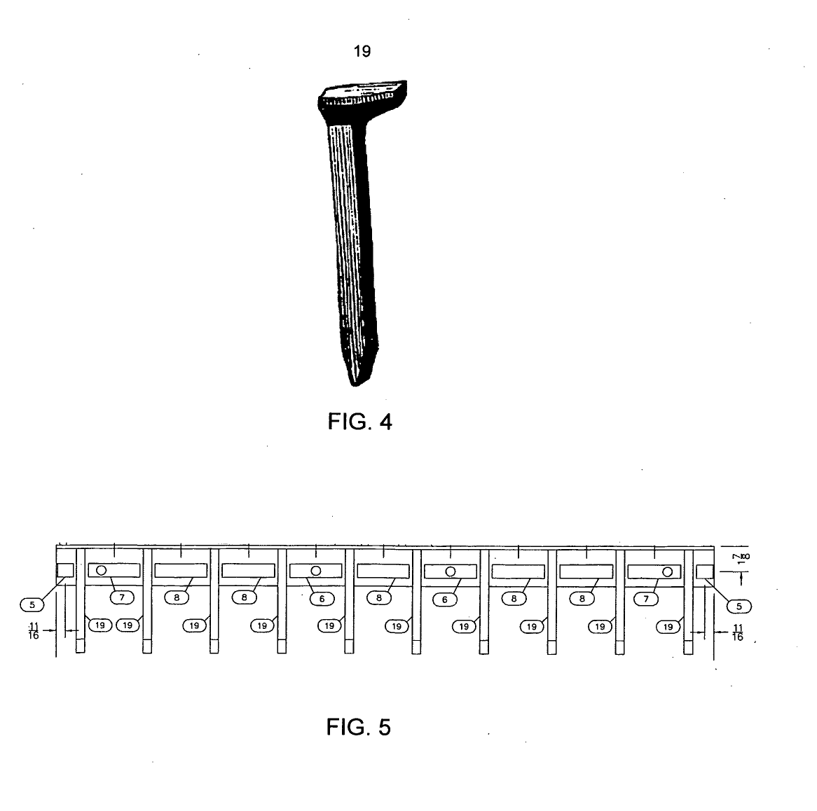

As shown in FIG. 1-3, the clever use of recycled railroad spikes as tines 19 fixated by compression to the tine bar 15 reduces manufacturing costs while decreases maintenance expense for a wear item that requires replacement. Rake tines wear out quickly and having an inexpensive tine replacement that can be installed by the user is very desirable. To better show the tine 19 (railroad spike) before attached to the tine bar 15, FIG. 4 is included to further enhance enablement and clarify the invention.

To secure the railroad spikes as tines 19, a compression bar 12 which could be a piece of angle iron as shown with through holes matching that of the tine mount holes 11 in the tine bar 15, such that threaded fasteners or bolts pass through the tine bar 15 at the tine mount holes 11, and then through the compression bar 12, wherein the tines 19 are captured between the tine bar 15 and compression bar 12, as the desired pressure is applied by tightening the tine bar 15 to the compression bar 12. Many different materials and metal products were considered and/or experimented with in constructing the compression bar 12 such that the railroad spike tines 19 could be secured to the tine bar 15 with the minimum number of threaded fasteners passing through the tine mount holes 11. The brute force method was to locate a through hole fastener between each tine 19, but by selecting the correct material, more than one tine 19 could be held in a row with a single through hole fastener.

The preferred material for the compression bar 12 proved to be ½″×1″-½″×¼″ angle iron. The consistent pressure by the compression bar 12, slightly deflecting at each railroad spike tine 19, allowed at least two, and for consistent railroad spikes, up to three spike tines 19 secured between tine mount holes 11. This method worked well so long as the railroad spikes were not too deformed, rusty, or bent. In those more damaged spike cases the compression bar would secure some of the spike tines 19, but not all adequately, and unwanted shifting would result.

The more damaged recycled railroad spikes as used for spike tines 19 in the preferred embodiment were usually worn, deformed, and no longer perfectly straight or consistent in dimension. As shown in FIG. 5, applicant succeeded in using inexpensive flat bar having a ½″ thickness and a width of one inch as a spacer 6-8, locating one spacer 6-8 between each spike tine 19 as positioned on the tine bar 15. With the rust and deformation impacting the thickness of the railroad spike, the ½″ thickness of the spacers 5-8 proved to be perfect, as the rail road spike thickness with rust and deformation was slightly less than ½″. This slight difference provided an unanticipated success when combined with the compression bar 12 and tine bar 15 in that, when tightened together having the railroad spike tines 19, and spacers 6-8 in between, the compression bar 12 only deflected until matingly contacting the spacer 5-8, rather than deflecting too much over a single railroad spike 19 causing an adjacent tine 19 to become loose. The addition of spacers 5-8 allowed for the recycling of almost all used railroad spikes as spike tines 19, rather than the few that were not badly deformed.

Having thus described the invention, what I claim is:

1. A chisel plow leveler rake assembly having a ripper bar with end plates including right and left link mounts with a vertical tube welded in between, a plurality of plow shoes connected transversely to said ripper bar, said vertical tube having a top front mount and a top rear mount such that the right link mount, left link mount, and top front mount provide three points of connection to a tractor, the improvement comprising:
said endplates each having a float pivot providing rotational connection for two float bars at a first end, each float bar rigidly connected to a tine bar on the second end;
said tine bar having a bottom rear mount welded between said float bars such that an adjustable rear link connects said tine bar at the bottom rear mount and connects said ripper bar at said top rear mount, whereby the depth of said tine bar relative to said ripper bar is changeable by adjusting the rear link; and a compression bar removably engagable to said tine bar such that a plurality of spike tines transversely secure between said tine bar and said compression bar.

2. A chisel plow leveler rake assembly having a ripper bar with end plates including right and left link mounts with a vertical tube welded in between, a plurality of plow shoes connected transversely to said ripper bar, said vertical tube having a top front mount such that the right link mount, left link mount, and top front mount provide three points of connection to a tractor, the improvement comprising:
said endplates each having a float pivot providing rotational connection for two float bars at a first end, each float bar rigidly connected to a tine bar on the second end whereby said tine bar freely travels up and down paralleling the depth of the ripper bar, rotating about the axis defined between the float pivots; and
said tine bar being removably engagable to a compression bar such that a plurality of spike tines transversely secure between said tine bar and said compression bar.

3. The chisel plow leveler rake assembly of claims 1 and 2, including spacers constructed and arranged to fit between each spike tine, such that each spike tine maintains a spacer distance from one another.

4. The chisel plow leveler rake assembly of claims 1 and 2, wherein said compression bar and said tine bar include aligned through holes between each spike tine providing a location for threaded fasteners to secure said compression bar to said tine bar such that the compression bar bends around each spike tine whereby different sized spike tines secure to the tine bar and thus recycled railroad spikes may be used as spike tines.

5. The chisel plow leveler rake assembly of claims 1 and 2, wherein said tine bar includes a weight mount for increasing force on the tine bar.

6. The chisel plow leveler rake assembly of claim 1, wherein said adjustable rear link includes a threaded shaft.

7. The chisel plow leveler rake assembly of claim 1, wherein said adjustable rear link includes a spring.

8. The chisel plow leveler rake assembly of claim 1, wherein said adjustable rear link includes a hydraulic cylinder.

9. The chisel plow leveler rake assembly of claims 1 and 2, wherein a spacer is located between spike tines, said spacer having a length matching the desired spacing between said spike tines and a thickness less than the thickness of said spike tines such that said compression bar matingly contacts said spike tines and said spacers, and thus varying sizes of spike tines are secured together on said tine bar.

10. The chisel plow leveler rake assembly of claims 1 and 2, wherein a half inch thick spacer is located between spike tines such that said compression bar matingly contacts said spacers securing varying sizes of spike tines together on said tine bar.

11. The chisel plow leveler rake assembly of claims 1 and 2, wherein only one float bar connects the tine bar to the ripper bar.
